(19) United States
(12) Patent Application Publication
(10) Pub. No.: US 2014/0014381 A1
(43) Pub. Date: Jan. 16, 2014

(54) MACHINING APPARATUS

(71) Applicants: Roger Anda, Kleppe (NO); Matz Kleppe, Bryne (NO)

(72) Inventors: Roger Anda, Kleppe (NO); Matz Kleppe, Bryne (NO)

(21) Appl. No.: 13/981,902

(22) PCT Filed: Jan. 16, 2012
(86) PCT No.: PCT/NO12/00004

§ 371 Date: Sep. 30, 2013

(30) Foreign Application Priority Data
Jan. 27, 2011 (NO) 20110145

(51) Int. Cl. B23Q 5/04

(52) U.S. Cl. CPC B23Q 5/04
USPC 173/31; 173/50; 173/213; 173/216

(57) ABSTRACT

A machining apparatus arranged to work an internal ma-chining surface of a workpiece is described, the machining apparatus including one or more tools rotatably supported in a housing and projecting, at least partially, from the periphery of the housing, wherein at least one driving roller is arranged, radially displaceable, in a cut-out in the housing diametrically opposite the tool, and the driving roller is connected to an adjusting mechanism which includes a turnable adjusting sleeve which surrounds substantially the whole of a driving motor and is arranged substantially concentrically to the driving motor.

A machining apparatus arranged for grindingly or cuttingly working an internal machining surface of a workpiece is described.

During the machining, for example cutting machining, polishing and the like, of internal surfaces of pipes et cetera, the locating of a working tool will, as a rule, be done relative to the centre axis of the relevant opening. Repair of internal grooves, bearing surfaces et cetera will typically be done with a rotating tool which is centred in the opening, and the accuracy of the work carried out is thereby dependent on the centring chosen being correct. Tool rotation around the centre axis of the opening will not take into account whether the cross section of said opening exhibits a non-circular form, for example owing to deformation of the element to be worked, and the finished surface may thereby have a wrong shape or be non-concentric relative to adjacent portions of the element. Typical examples of areas in which such working is complicated and sufficient accuracy hard to achieve are found within subsea installations in oil and gas fields offshore, especially pipe-end portions and the like, and in particular elements of circular or ellipsoidal cross sections.

From NO 20100318 a device for a remote-controlled subsea machining unit is known, which is arranged for the cutting machining of a surface of an installation element by the rotation and axial displacement of a tool head and the displacement of one or more shear holders relative to the tool head.

The invention has for its object to remedy or reduce at least one of the drawbacks of the prior art, or at least provide a useful alternative to the prior art.

The object is achieved through features which are specified in the description below and in the claims that follow.

A machining apparatus is provided, including a grinding or cutting tool rotatably supported in a housing and projecting, at least partially, from the periphery of the housing. The tool is connected to a driving gear including a driving motor. The tool is provided with one or more carrier rollers arranged to supportingly abut against a reference surface surrounding the machining apparatus in the position of application of the machining apparatus. The centre axis/axes of the carrier roller(s) may be arranged to coincide with the centre axis of the tool; in an embodiment arranged between two cylindrical or conical mills.

In the housing, substantially diametrically opposite the tool, a radially displaceable driving roller connected to said driving gear is arranged.

The driving gear is provided with transmission means which are arranged to selectively provide a transmission ratio between the rotational speeds of the tool and the driving roller so that the feed rate of the tool may be adjusted to the depth of cut, type of material, desired surface fineness et cetera. The transmission ratio may be altered by changing spur gears. Integrated in the driving gear, reduction gears may also be arranged, for example of the planetary gear type.

The housing may be provided with at least two supporting rollers which are resiliently supported in the housing, distantly arranged from the driving roller and preferably symmetrically around an axial plane coinciding with the centre axes of the tool and the driving roller, and, by abutment against said reference surface or some other surface surrounding the machining apparatus in the position of application of the machining apparatus, the supporting rollers are arranged to apply a pushing force to the driving roller towards said reference surface.

The driving roller may be connected to the driving gear via a telescopic articulated axle.

The driving roller is supported in a bearing pedestal which is radially movable in the housing and is connected to an adjusting mechanism. The adjusting mechanism may include an adjusting sleeve surrounding the driving motor. The adjusting mechanism may further include a gear transmission connected to the adjusting sleeve and a worm drive connected to an adjusting screw engaging in the bearing pedestal.

The bearing pedestal may include a spring system which makes the driving roller maintain an even pressure on the supporting roller(s) of the tool even if the reference surface does not exhibit a circular radial section.

The motor may be a hydraulic or electric motor.

The machining apparatus may be connected to a fluid system, wherein pressurized fluid may be passed out of one or more nozzles arranged in the machining apparatus, contributing to cuttings, polishing dust and other loose material being carried away from the reference surface and the machining apparatus. The fluid may be a gas, for example air, or a liquid, for example water.

The tool may be taken from a group consisting of a cylindrical mill, a conical mill, a profile cutter, a grinding tool and a polishing tool. The cutting means of the tool may be arranged on the periphery of the tool or on its free end surface.

More specifically, the invention relates to a machining apparatus arranged to work an internal machining surface of a workpiece, the machining apparatus including one or more tools that are rotatably supported in a housing and project, at least partially, from the periphery of the housing, characterized by at least one driving roller being arranged radially movable in a cut-out in the housing diametrically opposite the tool, and the driving roller being connected to an adjusting mechanism which includes a turnable adjusting sleeve surrounding substantially the whole of a driving motor and being arranged substantially concentrically to the driving motor.

The tool may be taken from the group consisting of polishing, grinding and cutting tools.

The adjusting mechanism may include a spindle which is in threaded engagement with a driving-roller bearing pedestal and connected to a worm drive rotationally in engagement with the adjusting sleeve.

Distantly from a worm, a worm shaft may be provided with an adjusting gear wheel engaging a gear rim arranged on the adjusting sleeve.

The gear rim may be arranged internally on the adjusting sleeve.

The tool and the driving roller may be connected to a driving gear arranged to rotate the tool and the driving roller at synchronous speed.

The tool and the driving roller may be connected to a driving gear which includes transmission means arranged for the selective setting up of a ratio between the rotational speeds of the tool and the driving roller.

The driving gear may include a telescopable articulated axle connected to the driving roller.

The tool may be provided with at least one carrier roller.

The tool may be provided with at least one carrier roller, the tool and the at least one carrier roller having coinciding centre axes.

The tool may be provided with at least one carrier roller which is arranged to roll, in an operative position, on a reference surface adjacent to the internal machining surface of the workpiece.

The housing may be provided with at least two supporting rollers which are resiliently suspended in the housing and, in an operative position, are arranged to abut supportingly against an internal surface in the workpiece and apply a pushing force to a driving roller towards an internal surface of the workpiece.

The supporting rollers may be arranged diametrically, substantially opposite the driving roller.

The supporting rollers may be arranged symmetrically around an axial plane coinciding with the centre axes of the tool and the driving roller.

One of the at least one driving roller, one or more carrier rollers and one or more supporting rollers may be provided with means that are arranged, by engagement with a portion of the workpiece, to fix the housing in the axial direction of the workpiece.

In what follows, an example of a preferred embodiment is described, which is visualized in the accompanying drawings in which:

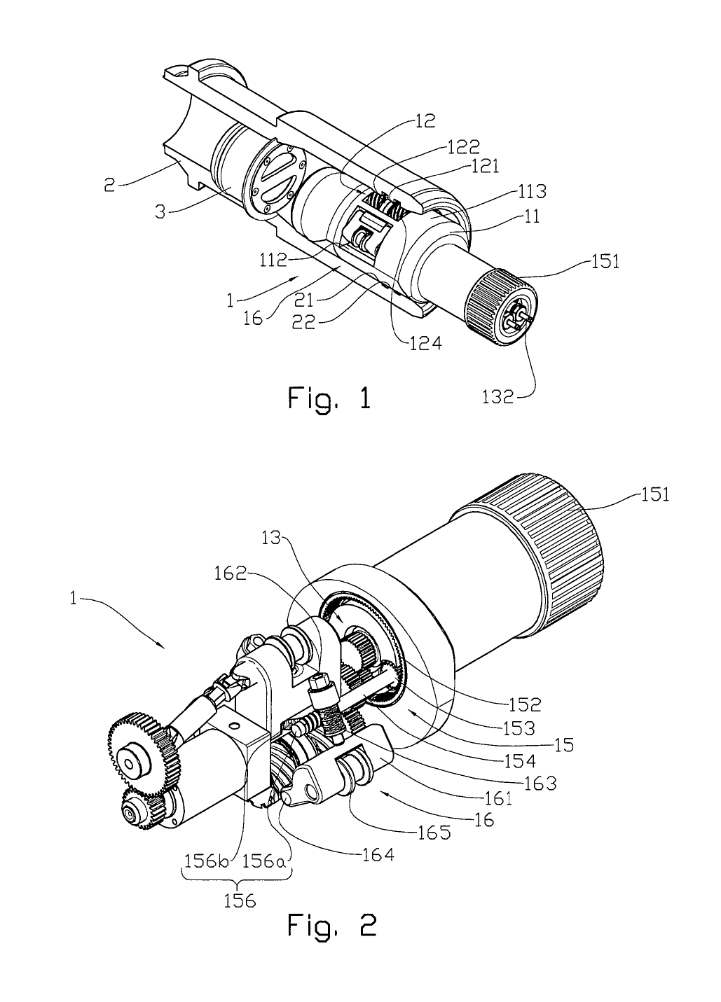

FIG. 1 shows, in perspective, a machining apparatus according to the invention positioned at an end portion of a workpiece, partially cut through, with the machining apparatus and a sealing device positioned in a centre opening in the workpiece;

FIG. 2 shows, in perspective, the machining apparatus on a larger scale, a portion of the housing having been removed for reasons of exposition;

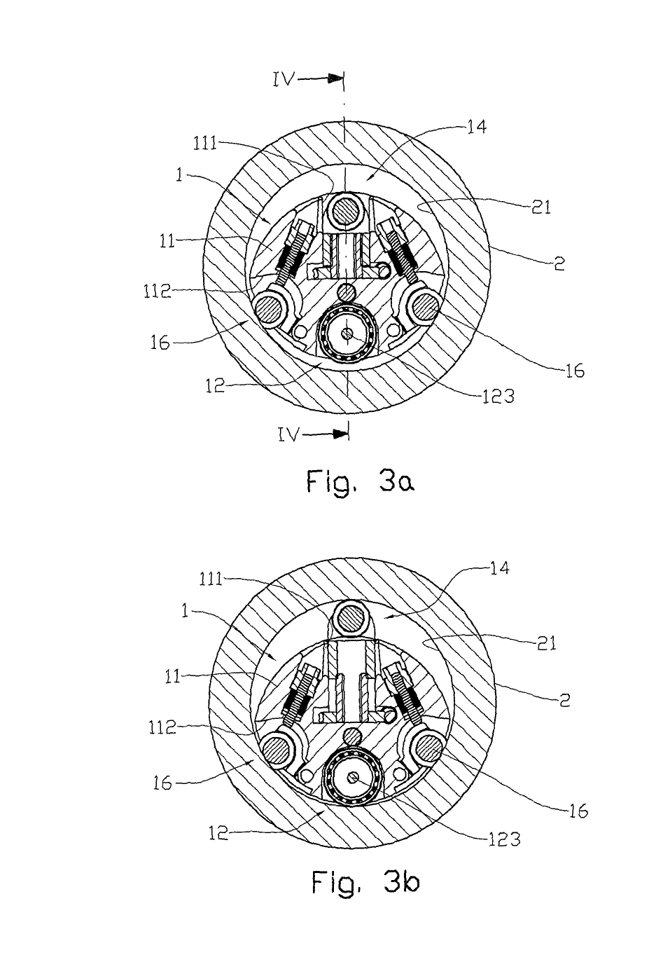

FIG. 3a shows a radial section through the machining apparatus placed in the workpiece;

FIG. 3b shows a radial section through the machining apparatus adjusted for working a machining surface in the workpiece; and

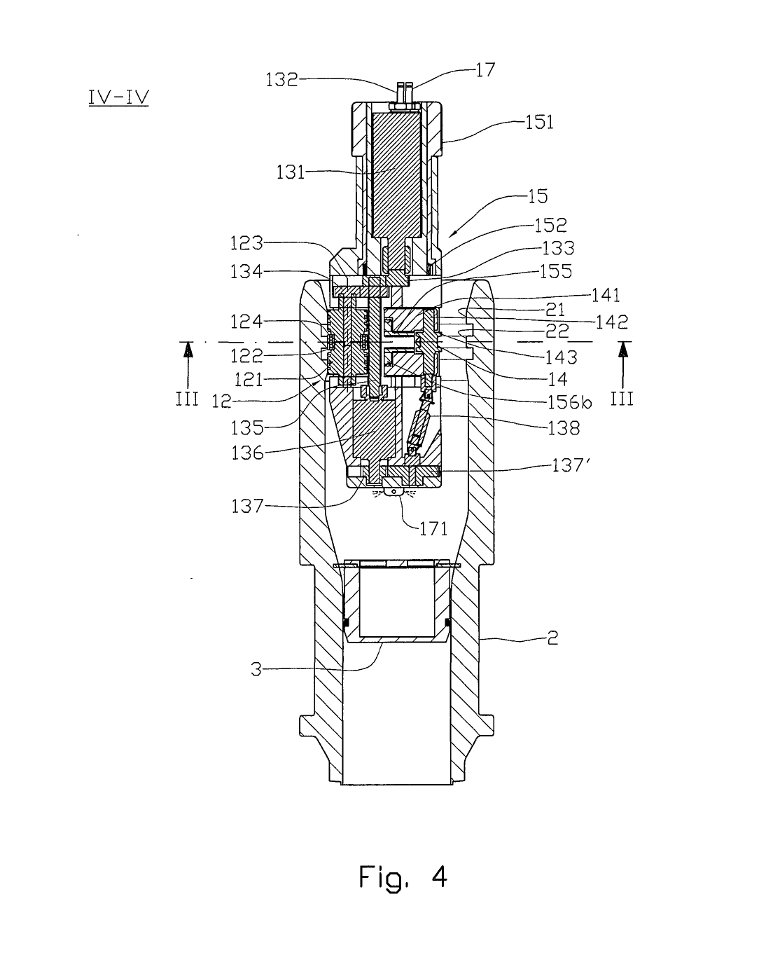

FIG. 4 shows an axial section through the machining apparatus positioned in the workpiece.

In the figures, the reference numeral 1 indicates a machining apparatus according to the invention. A tubular workpiece which is to be machined has the reference numeral 2, and temporarily arranged internally in the workpiece 2, there is a sealing device 3 which is arranged to catch machining chips et cetera during the working of an internal machining surface 21 in the workpiece 2.

The machining apparatus 1 is provided with a housing 11 which, among other things, is provided with a driving-roller guide 111 and two supporting-roller cut-outs 112 opening in a circumferential surface 113 of the housing 11.

A rotatable tool 12, shown here as a two-part cylindrical mill 121 provided with a carrier roller 122, shown here as a ball bearing arranged on a portion of the mill, is supported in a portion of the housing 11 rotatable around a tool centre axis 123. The supporting roller 122 is provided with annular side surfaces 124 arranged to abut supportingly against an internal shoulder surface (not shown) in the workpiece.

The tool 12 is connected to a driving gear 13. The driving gear 13 includes a driving motor 131 connected to a power source (not shown) via one or more power supply lines 132. A set of primary gear wheels 133 connects the driving motor 131 to a countershaft 135. The countershaft 135 is rotationally connected to the tool 12 via a set of tool gear wheels 134. The gear wheels 133, 134 provide necessary reversing of the direction of rotation and speed transmission. Distantly from the primary gear wheels 133, the countershaft 135 is connected to a reduction gear 136 which is connected, on its output shaft, to a set of intermediate gear wheels 137 arranged for further reversing of the direction of rotation and speed transmission. To the driven intermediate gear wheel 137′ which is supported in the housing 11, a telescopable articulated axle 138 is connected.

A radially displaceable driving roller 14 is connected via a driving-roller axle 142 to the articulated axle 138. The driving roller 14 is supported in a driving-roller pedestal 141 which is arranged in the drive-roller guide 111 in the housing 11. The driving roller 14 is provided with guide flanges 143.

Via the driving-roller pedestal 141, the driving roller 14 is connected to an adjusting mechanism 15. The adjusting mechanism 15 includes an adjusting sleeve 151 surrounding the driving motor 131 and is rotatably supported in the housing 11. An internal gear rim 152 in an end portion of the adjusting sleeve 151 is in engagement with an adjusting gear wheel 153 arranged on a worm shaft 154 rotatably supported in the housing 11. The worm shaft 154 is connected to a worm drive 156 including a worm 156a arranged on the worm shaft 154 and a worm wheel 156b arranged on a spindle 155 which is in engagement with the driving-roller pedestal 141 via threads.

Two supporting rollers 16 are rotatably supported in respective supporting-roller bearing housings 161 rotatably arranged around rocker shafts 164 in their respective supporting-roller cut-outs 112 in the housing 11. In a position of application, a portion of the supporting-roller bearing housing 161 arranged distantly from the rocker shaft abuts against a spring rod 162 which is provided with a spring device 163 arranged to apply an outward pushing force to the supporting roller 16.

In one embodiment (see FIG. 4), the machining apparatus 1 is provided with a nozzle 171 arranged in an end portion distant from the driving motor 131. The nozzle 171 is in fluid communication with a flushing-fluid line 17 via internal channels (not shown) in the machining apparatus 1. The flushing-fluid line 17 is connected to a flushing-fluid is system (not shown), for example a system that can supply the nozzle 171 with a liquid or a gas under high pressure.

The machining apparatus 1 provided with dimensions adjusted to the workpiece 2 to be worked is prepared by the transmission ratio of the driving gear 13 between the rotational speeds of the tool 12 and the driving roller 14 being defined through the choice of gear wheels 133, 134, 137 and possibly a reduction gear 136. The shape of the tool 12 is selected according to what is going to be the final shape of the machining surface 21, and the carrier roller 122 is selected on the basis of the shape of the reference surface 22, its definition relative to the machining surface 21, its radial distance from the centre of the workpiece 2 and so on.

The machining apparatus 1 is inserted into the workpiece 1 and located relative to the reference surface 22 which is shown in the figures as a cylinder surface between two grooves. The driving roller 14 is then moved into abutment against the reference surface 22 by the adjusting sleeve 151 being turned until the carrier roller 122 of the tool 12 abuts against the reference surface 22, possibly while the tool 12 is rotating. The telescopable articulated axle 138 provides for connection to be maintained between the driving roller 14 and the driving gear 13 in every position that the driving roller 14 may take. The abutment of the driving roller 14 against the same reference surface sets the machining tool 1 into slow, rotational motion with a prescribed feed rate for the tool 12 determined by the configuration of the driving gear 13.

When the reference surface 22 is non-circular, for example because of a deformation, it will be an advantage if, in the adjusting mechanism 15, possibly in the support of the driving roller 14, a spring device (not shown) which is arranged to maintain an even pressure between the reference surface 22 and the carrier roller 122 of the tool 12, or the driving roller 14, is provided.

1-15. (canceled)

16. A machining apparatus arranged to work an internal machining surface of a workpiece, the machining apparatus including one or more tools rotatably supported in a housing and projecting, at least partially, from the periphery of the housing, characterized in that at least one driving roller is arranged, radially displaceable, in a cut-out in the housing diametrically opposite the tool, and the driving roller is connected to an adjusting mechanism which includes a turnable adjusting sleeve which surrounds substantially the whole of a driving motor and is arranged substantially concentrically to the driving motor.

17. The machining apparatus in accordance with claim 16, wherein the tool is taken from the group consisting of polishing, grinding and cutting tools.

18. The machining apparatus in accordance with claim 16, wherein the adjusting mechanism includes a spindle which is in threaded engagement with a driving-roller pedestal and which is connected to a worm drive which is rotationally in engagement with the adjusting sleeve.

19. The machining apparatus in accordance with claim 18, wherein, distantly from a worm, a worm shaft is provided with an adjusting gear wheel in engagement with a gear rim arranged on the adjusting sleeve.

20. The machining apparatus in accordance with claim 18, wherein the gear rim is arranged internally on the adjusting sleeve.

21. The machining apparatus in accordance with claim 16, wherein the tool and the driving roller are connected to a driving gear arranged to rotate the tool and the driving roller at synchronous speed.

22. The machining apparatus in accordance with claim 16, wherein the tool and the driving roller are connected to a driving gear which includes transmission means arranged for the selective setting up of a ratio between the rotational speeds of the tool and the driving roller.

23. The machining apparatus in accordance with claim 16, wherein the driving gear includes a telescopable articulated axle connected to the driving roller.

24. The machining apparatus in accordance with claim 16, wherein the tool is provided with at least one carrier roller.

25. The machining apparatus in accordance with claim 16, wherein the tool is provided with at least one carrier roller, the tool and the at least one carrier roller having coinciding centre axes.

26. The machining apparatus in accordance with claim 16, wherein the tool is provided with at least one carrier roller which, in an operative position, is arranged to roll on a reference surface adjacent to the internal machining surface of the workpiece.

27. The machining apparatus in accordance with claim 16, wherein the housing is provided with at least two supporting rollers which are resiliently supported in the housing and, in an operative position, are arranged to abut supportingly against an internal surface in the workpiece and to apply a pushing force to a driving roller towards an internal surface of the workpiece.

28. The machining apparatus in accordance with claim 27, wherein the supporting rollers are arranged diametrically, substantially opposite the driving roller.

29. The machining apparatus in accordance with claim 27, wherein the supporting rollers are arranged symmetrically around an axial plane coinciding with the centre axes of the tool and the driving roller.

30. The machining apparatus in accordance with claim 16, wherein one of the at least one driving roller, one or more carrier rollers and one or more supporting rollers are provided with means which, by engagement with a portion of the workpiece, are arranged to fix the housing in the axial direction of the workpiece.
